(19) United States
(12) Patent Application Publication
(10) Pub. No.: US 2010/0281805 A1
(43) Pub. Date: Nov. 11, 2010

(54) FIRE RESISTANT COMPOSITE DOOR ASSEMBLY

(75) Inventors: Jared Andrew Garrett, Mentor, OH (US); Scott Evert Johnson, Kingsville, OH (US)

Correspondence Address: DUANE MORRIS LLP - Philadelphia;IP DEPARTMENT, 30 SOUTH 17TH STREET, PHILADELPHIA, PA, 19103-4196, US

(73) Assignee: Plastpro 2000, Inc., Los Angeles, CA (US)

(21) Appl. No.: 12/437,133

(22) Filed: May 7, 2009

(51) Int. Cl. E06B 5/16; E04C 2/20; E04C 2/24

(52) U.S. Cl. 52/309.4; 52/309.15; 52/784.11; 52/309.1

(57) ABSTRACT

A fire resistant door assembly is disclosed comprising a pair of horizontal rails, a pair of vertical stiles, first and second door skins, and a foam core. The first and second door skins are made from a molded fiberglass material that includes aluminum trihydroxide, which provides a degree of ultraviolet light resistance as well as fire resistance. The foam core is made from a polyurethane foam qualified to ASTM E84, Class I, while the stiles and rails are made from a polyvinylchloride material. The resulting door assembly is made from 100% composite material, provide a high degree of durability, while resulting in a door that maintains its structural integrity and resistance to smoke and fire in accordance with state and local building codes.

### FIELD OF THE INVENTION

The disclosure relates to composite door products in general, and more particularly to a fire resistant composite door product for use in commercial and residential applications.

### BACKGROUND

Residential and commercial exterior and interior doors have traditionally been fabricated from wood. While providing an aesthetically pleasing appearance, wood can have less than desired insulating and durability characteristics. Wood also can shrink and swell due to changes in humidity, and can warp or crack over time. Importantly, wood doors may also not be sufficiently fire-resistant to meet increasingly stringent building codes.

To be labeled or certified as a fire door, a door must fulfill the requirements of certain codes or standards that regulate the construction and installation of such doors. Private testing laboratories, such as Underwriters Laboratories and Warnock Hersey, may test for adherence to such codes or standards. The laboratories may also certify that a fire door meets fire protection requirements after conducting destructive testing of the door. Usually, this certification is expressed as a fire-rating offering a specific level of protection from fire, smoke, and/or heat for a limited amount of time. For example, a 20-minute fire-rated door should maintain its structural integrity and provide a barrier to fire, heat, and/or smoke for at least 20 minutes.

More recently, insulated metal faced doors have been used in residential and commercial applications. Metal doors can be less expensive than traditional solid wood doors, and they also have an increased resistance to fire. Despite these benefits, however, metal doors still may suffer from problems such as rusting, denting and delamination. In addition, metal doors typically cannot be trimmed, thus making them less desirable for use in renovation or refit applications.

Doors made from composite materials such as fiberglass and other polymers offer advantages over wood doors in that they are often less expensive, and they resist warping, swelling, shrinking and cracking over time. Composite doors also offer advantages over metal doors in that they can be trimmed, and they also resist denting and do not rust. Composite doors, however, still may not meet local building code requirements for fire resistance.

Thus; there is a need for an improved composite door product that overcomes the problems inherent with wood and metal door designs, namely that has good insulation characteristics, resists warping, permits trimming to fit existing door frame installations, and also has sufficient resistance to fire that it can meet or exceed relevant local building code requirements.

### SUMMARY

A fire resistant door assembly, comprising: a frame having first and second rails, and first and second stiles; first and second skin members engaged with the first and second rails and first and second stiles, the first and second skin members comprising a polymer glass fiber reinforced material, at least one of the first and second skin members further comprising aluminum trihydroxide (ATH); and a foam core disposed between the first and second skin members, the first and second rails, and the first and second stiles, the foam core comprising polyurethane having an ASTM E84, Class I rating.

A fire resistant door assembly is disclosed, comprising: a frame having first and second rails, first and second stiles, and first and second skin members engaged with the first and second rails and first and second stiles; and a foam core disposed between the first and second skin members, the first and second rails, and the first and second stiles, the foam core comprising polyurethane having an ASTM E84, Class I rating. The first and second skin members may comprise a fiber-reinforced material and aluminum trihydroxide (ATH). The first and second rails and the first and second stiles may comprise polyvinylchloride. The resultant door assembly may provide a barrier to fire, heat and/or smoke.

A fire resistant door assembly is disclosed, comprising: a frame having first and second rails, first and second composite stiles, and first and second skin members engaged with the first and second rails and first and second stiles; and a foam core disposed between the first and second skin members, the first and second rails, and the first and second stiles. The first and second skin members may comprise a fiberglass material and aluminum trihydroxide (ATH). The foam core may comprise polyurethane having an ASTM E84, Class I rating.

### BRIEF DESCRIPTION OF THE DRAWINGS The accompanying drawings illustrate preferred embodiments of the invention so far devised for the practical application of the principles thereof, and in which:

FIG. 1 is a top plan view of the disclosed fire resistant door;

FIG. 2 is a cross section view of the door of FIG. 1 taken along line 2-2;

FIG. 3 is a cross section view of the door of FIG. 1 taken along line 3-3;

FIG. 4 is a cross section view of the door of FIG. 1 taken along line 4-4;

FIG. 5 is a cross section view of the door of FIG. 1 taken along line 5-5; and

FIG. 6 is a cross section view of the door of FIG. 1 taken along line 6-6; and

FIG. 7 is a cross section view of the door of FIG. 1 taken along line 7-7.

### DETAILED DESCRIPTION

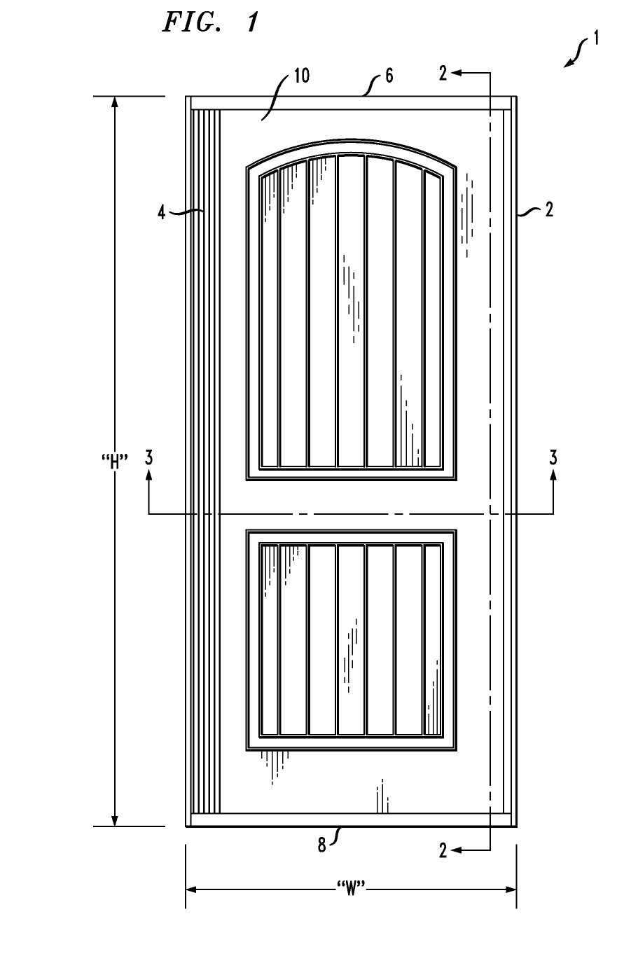

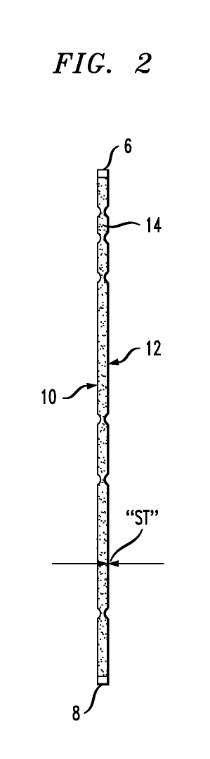

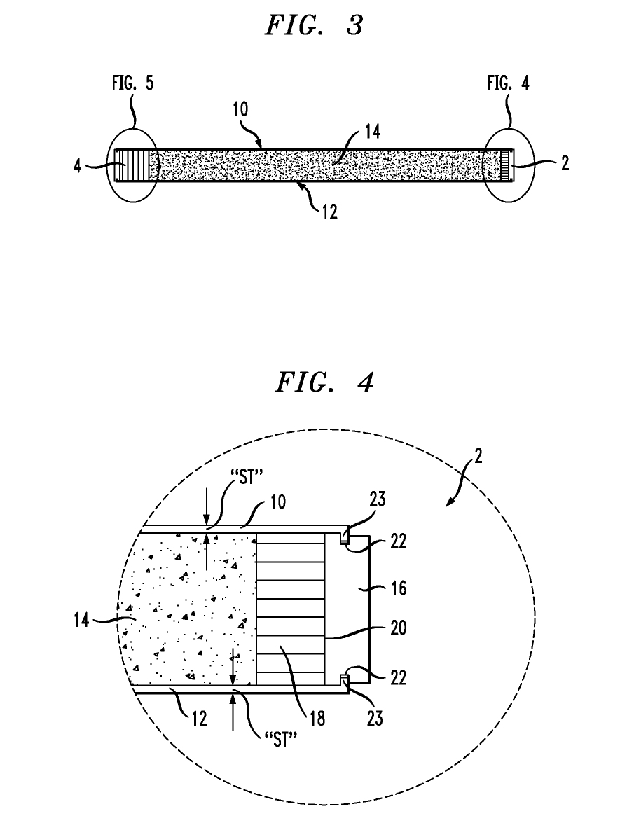

Referring to FIGS. 1-3, a composite door 1 may include first and second vertical stiles 2, 4, a pair of horizontal rails 6, 8, a pair of composite door panels or skins 10, 12 and a foam core 14 disposed between the skins 10, 12, the stiles 2, 4 and the rails 6, 8. The door may have a width “W” and a height “H” sized generally to fit within an opening formed by a doorframe of a residential or commercial building.

The first vertical stile 2 is, often referred to as the “hinge stile,” as it may be the stile to which the hinges are fixed. Likewise, second vertical stile 4 is often referred to as the “strike stile,” as it may be the stile to which the door knob and latch or strike are affixed. These designations are not critical.

Referring now to FIG. 4, the first vertical stile 2 may comprise first and second portions 16, 18, and is sized to receive the leaves of typical door hinges. The first portion 16 may be formed from a composite material such as a polymer (e.g., polyvinyl chloride (PVC)). In one embodiment, the first portion 16 is formed from a co-extrusion of PVC and wood flour. The first portion 16 may be trimmable to enable an installer to adjust the final width “W” of the door 1 to fit within the opening of an associated door frame using standard carpentry tooling such as saws, rasps and planes. The second portion 18 may be formed from a composite material similar to that used to form the first portion 16, or it may be formed from a different material such as Engineered Wood.

The first and second portions 16, 18 may be joined together along a common plane 20 using any of a variety of techniques. In one embodiment, the first and second portions 16, 18 are glued together. In an alternative embodiment, the first and second portions 16, 18 may comprise a single piece of material.

The first stile 2 may additionally have a plurality of skin-engaging recesses 22 configured to receive a downturn flange portion 23 of each of the door skins 10,12 to fix the stile 2 to the associated door skin 10, 12.

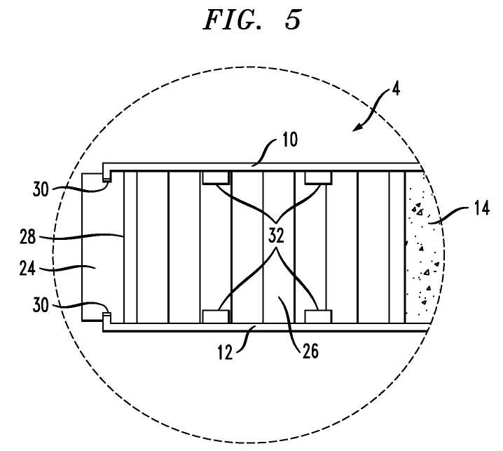

Referring to FIG. 5, the second vertical stile 4 comprises first and second portions 24, 26, and is sized to receive a door knob assembly and latch or strike. The first portion 24 may be formed from a composite material such as a polymer (e.g., PVC). In one embodiment, the first portion 24 is formed from a co-extrusion of PVC and wood flour. The first portion 24 may be trimmable to enable an installer to adjust the overall width “W” of the door 1 to fit within the opening of an associated door frame using standard carpentry tooling such as saws, rasps and planes. The second portion 26 may be formed from a composite material similar to that used to form the first portion 24, or it may be formed from a different material such as Engineered Wood.

The portions 24, 26 may be joined together along common plane 28 using any of a variety of techniques. In one embodiment, the first and second portions 24, 26 may be glued, bonded or affixed together using various techniques. In an alternative embodiment, the first and second portions 24, 26 may comprise a single piece of material.

This second stile 4 may have a plurality of skin-engaging recesses 30, 32 formed in the first and second portions 24, 26, respectively. These recesses are for clearance purposes related to the associated door skin 10, 12 design and may or may not be present. Stile 4 may be glued, bonded or affixed to the associated door skins 10, 12 using various methods.

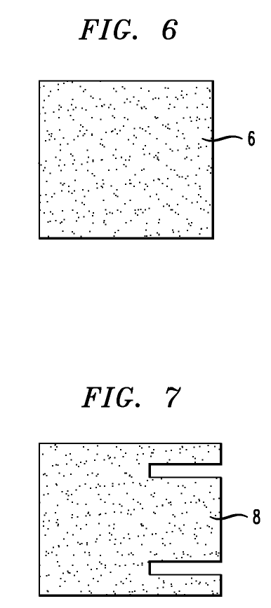

Referring now to FIGS. 6 and 7, horizontal rail 6 may form the top of the door 1, while horizontal rail 8 may form the bottom of the door 1. These horizontal rails 6, 8 may be joined to the first and second vertical stiles 2, 4 by any of a variety of mechanical or chemical joining techniques, such as mechanical fastening, bonding, glue, and the like. The horizontal rails 6, 8 may comprise wood flour, polymer such as PVC or a combination of the two. In one embodiment the horizontal rails 6, 8 comprise PVC and wood flour.

The horizontal rails 6, 8 that form the top and bottom of the door 1, respectively, may be trimmable in the manner described in relation to the first and second stiles 2, 4 to enable an installer to adjust the overall height “H” of the door 1 to fit within the opening of an associated door frame using standard carpentry tooling such as saws, rasps and planes. The ends of the horizontal rails 6, 8 may also be trimmable to enable the rails 6, 8 to be trimmed along with the associated stiles 2, 4.

Door skins 10, 12 (FIGS. 1-3) may be formed using a compression molding technique to achieve a smooth surface, unique texture design, or a simulated wood texture and grain on their exterior surfaces. The door skins may be made from a thermoset or thermoplastic material, a non-limiting list of exemplary materials including polypropylene, polyester, styrene and polystyrene.

The door skins may also include a variety of additives such as calcium carbonate, chopped fiber strands (e.g., glass fiber), and pigments to provide desired strength, rigidity and/or color. In addition, at least one of the door skins may incorporate an ultraviolet (UV) light resistant compound and/or a fire retardant compound, and release agents such as calcium stearate or zinc stearate.

In one embodiment, at least one of the door skins 10, 12 is made from a fiberglass sheet molding compound including a fire retardant additive. The door skins may comprise a polymer component, a fibrous glass component, and a fire retardant component. In addition, the door skins may comprise one or more release agents comprising zinc stearate and/or calcium stearate.

The door skins 10, 12 may have a fibrous glass content of about 15%-40% by weight, and in one exemplary embodiment the fibrous glass content may be about 18%-24%, by weight. The fire retardant additive may comprise aluminum trihydroxide (ATH), often referred to as “hydrated alumina.” The door skins 10,12 may have an ATH content of about 30%-60%, by weight. In one exemplary embodiment, the ATH content may be about 42-52%, by weight. In addition to its fire retardant properties, ATH also provides the door skins 10, 12 with protection from ultraviolet (UV) light.

The door skins 10, 12 may have a skin thickness “ST” of from about 0.060-inches to about 0.150-inches. Particular embodiments may have skin thicknesses of about 0.075-in ±0.008-in (for entry doors), or 0.125-in ±0.010-in (for impact doors). Increased skin thickness may also provide enhanced fire resistance due to the increased volume of ATH present.

The door skins 10, 12 may be firmly adhered or bonded to the stiles 2, 4 rails 6, 8 and core 14 by means of an adhesive.

In one embodiment, the door skins 10, 12 comprise a material that can be trimmed along with the associated vertical stile 2, 4 and horizontal rail 6, 8 to adjust the overall width “W” of the door 1 so that it can fit within the opening of an existing door frame. This enables the installer to make substantial adjustments in the width “W” of the door 1 to fit the door to the unique dimensions of a particular door frame opening. As previously noted, such flexibility enables the door 1 to be custom-fit to door openings in older buildings which often have irregular (e.g. non-standard or non-square) dimensions.

The foam core 14 may be comprised of a foam material that fills the interior of the door 1, and may be selected to provide desired acoustic and/or thermal insulation properties. The foam core 14 may comprise any of a variety of rigid plastic foams, and in one embodiment, the foam core 14 comprises a Class I (ASTM E84) polyurethane foam material. The term “Class 1” refers to a material that exhibits a Flame Spread of 25 or less, and a Smoke Development of 450 or less, when tested according to ASTM E 84 “Standard Test Method for Surface Burning Characteristics of Building Materials.” ASTM E E84 is a widely recognized standard used to classify the surface burning behavior of building materials such as insulation, paneling, flooring, etc. Many building codes in the United States reference ASTM E 84, which rates a product for its “Flame Spread” and “Smoke Development”. The Flame Spread number is a calculation, not a direct measurement, which takes into account the time of ignition, rate and extent of burn, and is a comparison of the tested material relative to a totally non-combustible material (e.g. inorganic cement) with a Flame Spread of zero (0), and untreated red oak, which has a defined Flame Spread of 100. As indicated, the Flame Spread is not a time rating. A photovoltaic eye measures smoke density and the number value should be equal to or less than 450 for a Class 1 designation. This smoke number is a direct measurement.

A non-limiting example of an appropriate foam core material is sold under the trade name Elastopor® Rigid Polyurethane Foam System, manufactured by BASF Corporation, 1609 Biddle Avenue, Wyandotte, Mich. 48192; www.basf.com/pur. The Elastopor® Rigid Polyurethane Foam System is a two component system comprising a polyol resin component (Elastopor® P 17227R Resin) and an isocyanate component (Elastopor® P 1001U Isocyanate).

The foam core 14 may be preformed and then inserted into the space between the skins, or it may be foamed-in-place. The foam material may have a density of about 1.7 pounds per cubic foot (pcf) to about 4.0 pcf, and in one embodiment, the foam material may have a density of about 2.75 pcf ±0.05 pcf.

The disclosed door assembly is a 100% composite door which combines the features of fiberglass door skins (with ATH), Class I polyurethane foam, and PVC rails and stiles, and which results in a structure that maintains its structural integrity and provides a barrier to fire, heat and/or smoke for at least 20 minutes. The inventors believe this superior performance is due to the combined action of the fire-retardant fiberglass skins and the Class I polyurethane foam. Specifically, it is believed that the Class I foam turns to ash when subjected to high temperature, which then acts as an insulator to the opposing door skin.

The disclosed design provides a 100% composite door that provides the highest level of durability and resistance to in-use and installation damage, while still meeting relevant fire resistance standards. The composite rails and stiles provide a high degree of moisture protection and also facilitate easy trimming of the door, which is desirable for refit applications.

It should be understood that the embodiments disclosed herein are merely illustrative of the principles of the invention. Various other modifications may be made by those skilled in the art which will embody the principles of the invention and fall within the spirit and the scope thereof.

What is claimed is:

1. A fire resistant door assembly, comprising:
a frame having first and second rails, and first and second stiles;
first and second skin members engaged with the first and second rails and first and second stiles, the first and second skin members comprising a polymer glass fiber reinforced material, at least one of the first and second skin members further comprising aluminum trihydroxide (ATH); and
a foam core disposed between the first and second skin members, the first and second rails, and the first and second stiles, the foam core comprising polyurethane having an ASTM E84, Class I rating.

2. The fire resistant door assembly of claim 1, wherein the first and second stiles comprise polyvinylchloride.

3. The fire resistant door assembly of claim 1, wherein at least one of the first and second rails comprises polyvinyl chloride.

4. The fire resistant door assembly of claim 1, wherein the first and second stiles each comprise a trimmable portion.

5. The fire resistant door assembly of claim 3, wherein the first and second skin members are trimmable.

6. The fire resistant door assembly of claim 1, wherein the first and second skin members further comprise a material selected from the list consisting of chopped fiber strands, pigment, calcium stearate and zinc stearate.

7. The fire resistant door assembly of claim 1, wherein at least one of the first and second skin members comprises an ATH content in the range of about 30%-60%, by weight.

8. The fire resistant door assembly of claim 7, wherein at least one of the first and second skin members comprises a fibrous glass content in the range of about 15%-40%, by weight.

9. A fire resistant door assembly, comprising:
a frame having first and second rails, first and second stiles, and first and second skin members engaged with the first and second rails and first and second stiles; and
a foam core disposed between the first and second skin members, the first and second rails, and the first and second stiles, the foam core comprising polyurethane having an ASTM E84, Class I rating;
wherein the first and second skin members comprise a fiber-reinforced material and aluminum trihydroxide (ATH);
wherein the first and second rails and the first and second stiles comprise polyvinylchloride; and
wherein the door assembly provides a barrier to fire, heat and/or smoke.

10. The fire resistant door assembly of claim 9, wherein the fiber-reinforcement comprises glass fiber.

11. The fire resistant door assembly of claim 9, wherein the first and second skin members further comprise a material selected from the list consisting of chopped fiber strands, pigment, calcium stearate and zinc stearate.

12. The fire resistant door assembly of claim 9, wherein the first and second stiles each comprise a trimmable portion.

13. The fire resistant door assembly of claim 9, wherein the first and second skin members are trimmable.

14. The fire resistant door assembly of claim 9, wherein at least one of the first and second rails comprises a trimmable composite material.

15. The fire resistant door assembly of claim 9, wherein at least one of the first and second skin members comprises an ATH content in the range of about 30%-60%, by weight.

16. The fire resistant door assembly of claim 15, wherein at least one of the first and second skin members comprises a fibrous glass content in the range of about 15%-40%, by weight.

17. A fire resistant door assembly, comprising:
a frame having first and second rails, first and second composite stiles, and first and second skin members engaged with the first and second rails and first and second stiles; and
a foam core disposed between the first and second skin members, the first and second rails, and the first and second stiles;
wherein the first and second skin members comprise a fiberglass material and aluminum trihydroxide (ATH); and
wherein the foam core comprises polyurethane having an ASTM E84, Class I rating.

18. The fire resistant door assembly of claim 17, wherein the first and second stiles comprise polyvinylchloride.

19. The fire resistant door assembly of claim 17, wherein the first and second rails comprise polyvinylchloride.

20. The fire resistant door assembly of claim 17, wherein the first and second skin members are trimmable.

21. The fire resistant door assembly of claim 17, wherein the first and second skin members further comprise a material selected from the list consisting of chopped fiber strands, pigment, calcium stearate and zinc stearate.

22. The fire resistant door assembly of claim 17, wherein at least one of the first and second skin members comprises an ATH content in the range of about 30%-60%, by weight.

23. The fire resistant door assembly of claim 22, wherein at least one of the first and second skin members comprises a fibrous glass content in the range of about 15%-40%, by weight.

24. The fire resistant door assembly of claim 23, wherein at least one of the first and second skin members comprises a fibrous glass content in the range of about 15%-40%, by weight.
